(19) United States
(12) Patent Application Publication
(10) Pub. No.: US 2017/0102781 A1
(43) Pub. Date: Apr. 13, 2017

(54) COMPUTER KEYBOARD AND MOUSE COMBO DEVICE

(71) Applicant: Peigen Jiang, Sammamish, WA (US)

(72) Inventor: Peigen Jiang, Sammamish, WA (US)

(21) Appl. No.: 14/880,195

(22) Filed: Oct. 10, 2015

(51) Int. Cl. G06F 3/02; G06F 3/00; G06F 3/0354

(52) U.S. Cl. CPC G06F 3/0219; G06F 3/03543; G06F 3/005

(57) ABSTRACT

A computer input method is disclosed which includes detecting touch on a surface of a keyboard of a keyboard-and-mouse combo device, comparing a size of the touch with a predetermined value for determining a mode of operation for the keyboard-and-mouse combo device, entering the keyboard-and-mouse combo device into a mouse mode when the size of the touch is smaller than the predetermined value, and entering the keyboard-and-mouse combo device into a keyboard mode when the size of the touch is larger than the predetermined value.

### BACKGROUND

The present invention relates generally to human input devices for computing systems, and, more particularly, to a computer keyboard and mouse combo device.

A most popular way to move a cursor around on a computer display is to use a mouse, which functions by detecting two dimensional motions relative to its supporting surface. Physically, a mouse comprises an object held under one of a user's hands, with one or more buttons. Clicking or hovering (stopping movement while the cursor is within the bounds of an area) can select files, programs or actions from a list of names, or (in graphical interfaces) through small images called “icons” and other elements. For example, a text file might be represented by a picture of a paper notebook, and clicking while the cursor hovers over this icon might cause a text editing program to open the file in a window.

When mice have more than one button, software may assign different functions to each button. A primary button (leftmost button in a right-handed configuration) on the mouse, when clicked, will select items, and such click is generally called primary click. A secondary button (rightmost button in a right-handed configuration) on a mouse, when clicked, will bring up a menu of alternative actions applicable to that item, and such click is generally called secondary click.

A conventional keyboard can detect a pressing of any key thereof, but cannot detect mere touches on the keys. Here, the “touch” refers to a surface of the keyboard being contacted by an object regardless if the key is pressed or not. If the conventional keyboard is a tactile one, the key pressing results from the key being depressed. If the conventional keyboard is a surface one, such as Touch Cover for Microsoft Surface, the key pressing results from a force being applied on the key. As long as the key remains depressed in tactile keyboard or forced upon in surface keyboard, the key is pressed.

While conventional mice can be highly accurate pointing devices for computers, being a separate device the conventional mice have some short-comings, such as every time when a computer user wants to move a cursor, he or she has to move his or her hand away from the keyboard and to the mouse, and move the mouse as a physical object. It is not only less efficient but also may cause injury to the hand over an extended period of time of use.

As such, what is desired is a computer input device, particularly a pointing device that does not rely on moving any additional object other than the user's fingers.

### BRIEF DESCRIPTION OF THE DRAWING

FIG. 1 is a perspective view of a laptop computer with a keyboard.

FIG. 2 illustrates an infrared-light touch sensing system.

FIG. 3 illustrates a keyboard and mouse combo device with a camera-based touch sensing system.

FIG. 4 is a block diagram of a computing system with a keyboard-mouse combo device according to the embodiment of present invention.

FIG. 5 is a flow chart diagram illustrating steps of operations of the keyboard-mouse combo device according to an embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to a computer input device utilizing a touch sensing device and a conventional keyboard to provide cursor input for the computer. A preferred embodiment of the present invention will be described hereinafter with reference to the attached drawings.

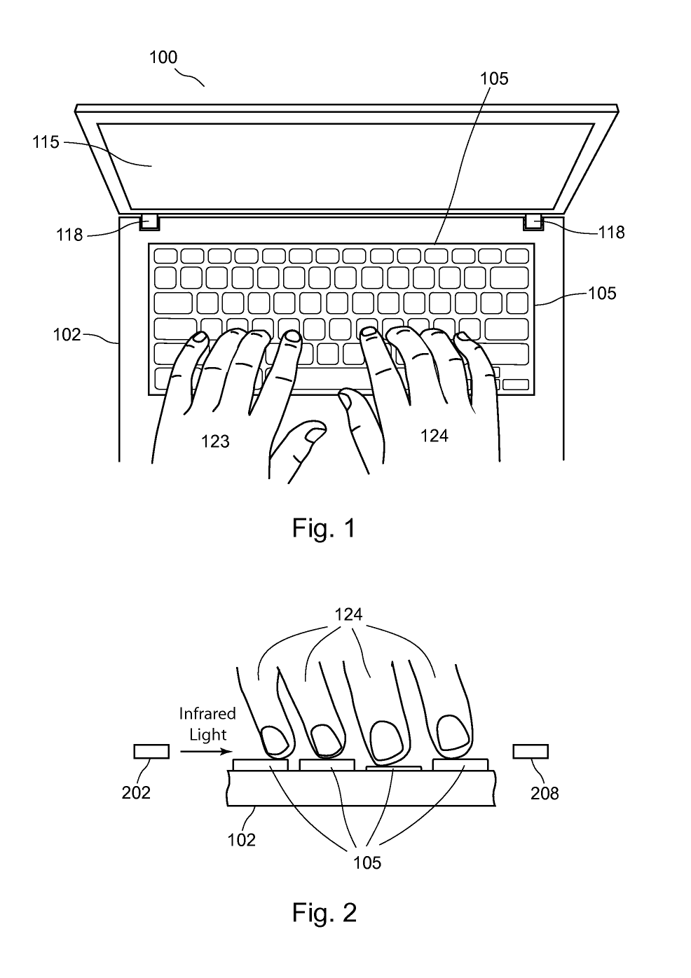

FIG. 1 is a perspective view of a laptop computer 100 with a conventional keyboard 105 for entering text, etc. The laptop computer 100 has a base unit 102 containing the keyboard 105, and a display panel 115 which is hinged to the base unit 102 by hinges 118. A skilled computer user can generally type on the keyboard 105 with both hands 123 and 124.

FIG. 2 illustrates an infrared-light touch sensing system positioned to detect touches on the surface of the keyboard 105. The infrared-light touch sensing system includes an infrared light emitter 202 and an infrared light receiver 208. The infrared light travels across the surface of the keyboard 105. A finger 124 or any other object touching the surface of the keyboard 105 blocks the infrared light from being received by the infrared light receiver 208. As a result, the touch can be detected.

Referring back to FIG. 1, the infrared light emitter 202 can be positioned along one edge of the keyboard 105 and the infrared light receiver 208 can be positioned along the opposite edge of the keyboard 105. In order to obtain coordinates of a touch, two sets of the infrared light touch sensors will be needed with one set positioned on the horizontal edges and the other on the vertical edges.

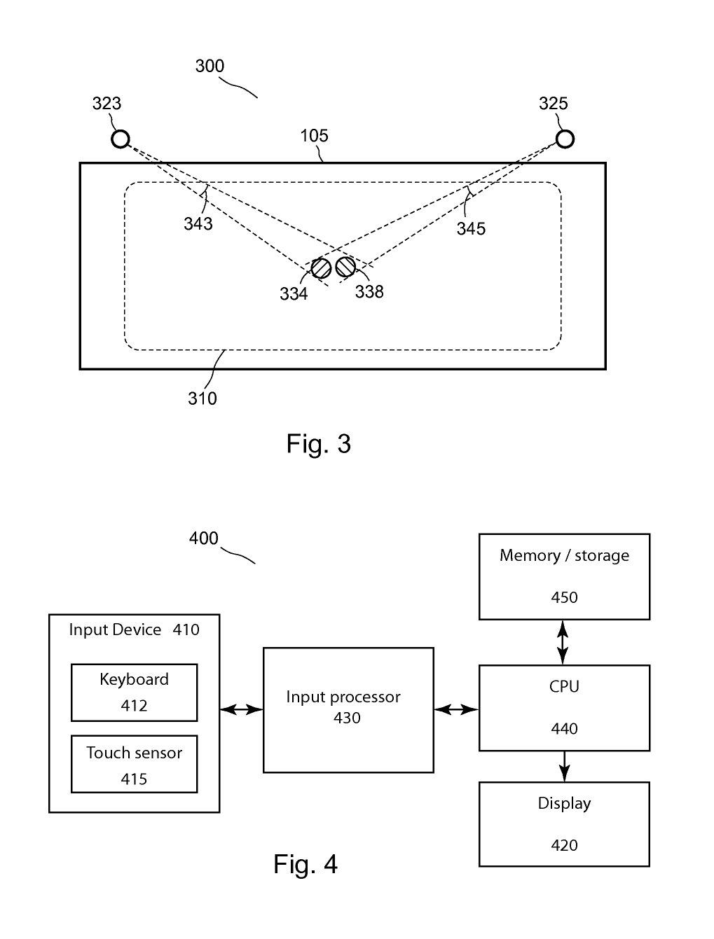

FIG. 3 illustrates a keyboard and mouse combo device 300 with a camera-based touch sensing system. In one embodiment, the camera-based touch sensing system employs two cameras 323 and 325 placed near the top corners of the keyboard 105. The camera 323 has the entire view of a predetermined touch sensing area 310 from the top left corner. The camera 325 has the entire view of the touch sensing area 310 from the top right corner. Detections from both cameras 323 and 325 can be used to calculate a location of a touch on the surface of the keyboard 105. The touch sensing area 310 can be defined by software or limited by the viewing angle of the cameras 323 and 325. According to the embodiment of the present invention, the touch sensing area 310 is smaller than the surface of the keyboard 105, so that some of the keys, such as the function (fn) key, is located outside of the touch sensing area 310.

In one embodiment, each of the cameras 323 and 325 includes a light source and a linear image sensor (not shown). Light reflectors are then placed at the left, bottom and right edge of the keyboard 105 (not shown). Both the cameras 323 and 325 and the light reflectors are mounted slightly above the surface of the keyboard 105, so that the light reflector is visible to the cameras 323 and 325. If the view is not blocked, the light source, through the reflectors, will create a bright straight line on the linear image sensor. In embodiments, the light source can be a light emitting diode (LED) emitting infrared light toward the light reflectors. The linear image sensor can be complementary metal-oxide-semiconductor (CMOS) image sensor.

In other embodiments, the camera 323 and 325 may not employ a light source, and instead rely on ambient light reflected by touching objects to detect their presence. In this case, light reflectors at the edges of the keyboard 105 will not be needed.

As shown in FIG. 3, there are two dots 334 and 338 representing two fingers touching the surface sensing area 310 of the keyboard 105. In this case, the linear image sensor in camera 323 will detect an image having a dark area corresponding to an angle 343; and the linear image sensor in camera 325 will detect an image having a dark area corresponding to an angle 345. The touch sensing system can then base on the dark areas to extract a size and coordinates of the touched area. As shown in FIG. 3, because the dots 334 and 338 are closely located, the touch sensing system will not be able to detect them as two separate dots, and see only one large touched area.

FIG. 4 is a block diagram of a computing system 400 with a keyboard-mouse combo (KMC) device according to the embodiment of present invention. The computing system 400 includes an input device 410, a display 420, an input processor 430, a central processing unit (CPU) 440 and a memory and storage unit 450. The input device 410 comprises a conventional keyboard 412 and a touch sensor 415 which overlays the conventional keyboard 410 as described in FIGS. 1-3. The conventional keyboard 412 and the touch sensor 415 form the KMC device. The input processor 430 is the hardware that executes the KMC software.

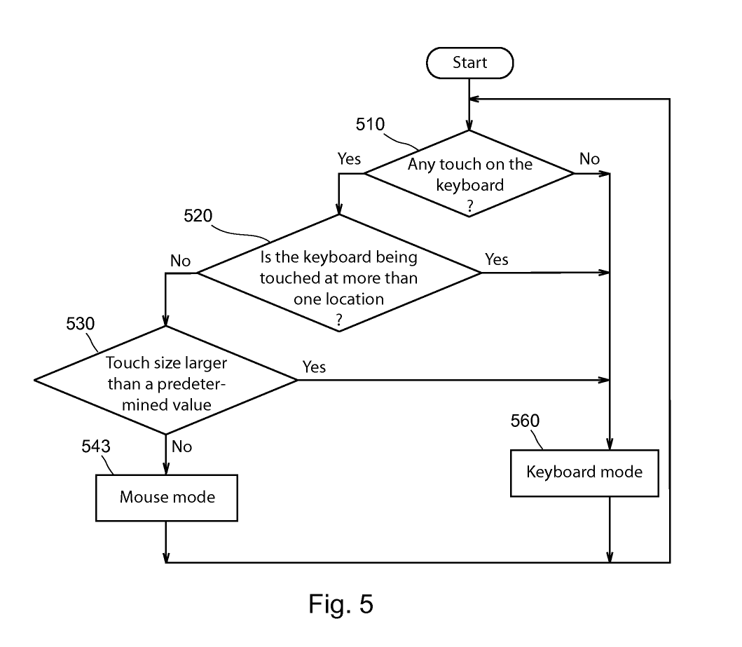

FIG. 5 is a flow chart diagram illustrating steps of an operation of the KMC device according to an embodiment of the present invention. The keyboard-mouse operation starts with detecting if the touch sensing area 310 is touched in step 510. The input processor 430 distinguishes a single touch from no-touch or multiple touches in step 520. Here the multiple touches refer to a situation when the touch sensing area 310 is simultaneously touched at multiple noncontiguous locations. If there is no single touch, i.e., the touch sensing area 310 is either not touched or simultaneously touched at multiple locations, the keyboard-mouse operation enters into a keyboard mode in step 560, in which when a key is pressed, the input processor 430 outputs a code corresponding to the pressed key, and cursor on the display 420 does not move in spite of a touch relocation.

If a single touch is detected in step 520, the keyboard-mouse operation further compares the size of the touch with a predetermined value in step 530. If the size of the touch is larger than the predetermined value, the input processor 430 will treat the touch as two adjacent ones and enter the keyboard-mouse operation into the keyboard mode in step 560. If the size of the touch is smaller than the predetermined value, the input processor will treat the touch as truly a single touch and enter the keyboard-mouse operation into a mouse mode in step 543. In one embodiment, the predetermined value is set at 18 millimeter, which is roughly the size of one finger. In other embodiments, the predetermined value can be field reset to a user preferred value.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A computer input method comprising:
detecting touch on a surface of a keyboard of a keyboard-and-mouse combo device;
comparing a size of the touch with a predetermined value for determining a mode of operation for the keyboard-and-mouse combo device;
entering the keyboard-and-mouse combo device into a mouse mode when the size of the touch is smaller than the predetermined value; and
entering the keyboard-and-mouse combo device into a keyboard mode when the size of the touch is larger than the predetermined value.

2. The computer input method of claim 1, wherein the detecting touch includes providing a light source over the surface of the keyboard and sensing light reflected by reflectors placed around edges of the keyboard.

3. The computer input method of claim 1, wherein the detecting touch includes placing infrared light emitters at one side of the keyboard and infrared light receivers at an opposite side of the keyboard.

4. The computer input method of claim 1, wherein the predetermined value is 18 millimeter.

5. The computer input method of claim 1 further comprising allowing user to reset the predetermined value.

6. The computer input method of claim 1 further comprising defining a touch sensing area smaller than the surface area of the keyboard to leave some of the keys outside of the touch sensing area.

7. A computer input device comprising:
a keyboard having a plurality of mechanical keys for entering commands and characters into the computer;
a touch sensor configured to detect touch on a surface of the keyboard;
an input processor configured to calculate size of the detected touch and determining a mode of operation based on the size of the detected touch,
wherein when the size is larger than a predetermined value, the mode of operation is keyboard mode, and when the size is smaller than the predetermined value, the mode of operation is a mouse mode.

8. The computer input device of claim 7, wherein the touch sensor includes a linear image sensor.

9. The computer input device of claim 8, wherein the touch sensor further includes light source and light reflectors, the reflectors being placed at an edge of the keyboard

10. The computer input device of claim 7, wherein the touch sensor includes infrared light emitters at one side of the keyboard and infrared light receivers at an opposite side of the keyboard.

11. The computer input device of claim 7, wherein the predetermined value is 18 millimeter.

12. The computer input device of claim 7, wherein the predetermined value can be reset by a computer user.

13. The computer input device of claim 7, wherein the touch sensor can only detect touch in the touch sensing area that is smaller than the surface area of the keyboard so that one or more keys are located outside of the touch sensing area.
